(19) United States
(12) Patent Application Publication
(10) Pub. No.: US 2026/0244925 A1
(43) Pub. Date: Aug. 20, 2026

(54) MACHINE LEARNING MODEL MINIATURIZATION AND DEPLOYMENT

(71) Applicant: Honeywell International Inc., Charlotte, NC (US)

(72) Inventors: Bhabesh Chandra Acharya, Bengaluru (IN); Jyoti Ranjan Senapati, Bengaluru (IN); A. Kumaresh Baabu, Bengaluru (IN); Kotni Ashutosh, Jharpada (IN)

(21) Appl. No.: 19/058,261

(22) Filed: Feb. 20, 2025

(51) Int. Cl. G06N 3/082

(52) U.S. Cl. CPC G06N 3/082

(57) ABSTRACT

Devices, methods, and systems for automated machine learning model miniaturization and deployment are described herein. One method includes determining device specifications for a number of devices, selecting a machine learning model for the number of devices based on a function to be performed by the number of devices, selecting a miniaturization model for the machine learning model based on the function, selecting configuration settings for the miniaturization model for the number of devices, generating corresponding miniaturized machine learning models for the number of devices utilizing the selected configuration settings, and deploying the corresponding miniaturized machine learning models to each the number of devices based on the function and the device specifications associated with the number of devices.

### TECHNICAL FIELD

The present disclosure relates generally to devices, methods, and systems for automated machine learning model miniaturization and deployment based on configuration of a receiving device.

### BACKGROUND

Machine learning models can be on a cloud device or centralized server to analyze data and/or generate outputs from the received data. For example, machine learning models can be utilized at a centralized server device to analyze data received from a plurality of devices associated with a system. In these examples, the machine learning model can be utilized to process data collected by the plurality of devices.

### BRIEF DESCRIPTION OF THE DRAWINGS

FIG. 1 illustrates an example of a method for automated machine learning model miniaturization and deployment in accordance with one or more embodiments.

FIG. 2 illustrates an example of a method for automated machine learning model miniaturization and deployment in accordance with one or more embodiments.

FIG. 3 illustrates an example of a system for automated machine learning model miniaturization and deployment in accordance with one or more embodiments.

FIG. 4 illustrates an example of a system for automated machine learning model miniaturization and deployment in accordance with one or more embodiments.

FIG. 5 is an example of a computing device for automated machine learning model miniaturization and deployment in accordance with one or more embodiments.

### DETAILED DESCRIPTION

Devices, methods, and systems for automated machine learning model miniaturization and deployment are described herein. One method includes determining device specifications for a number of devices, selecting a machine learning model for the number of devices based on a function to be performed by the number of devices, selecting a miniaturization model for the machine learning model based on the function, selecting configuration settings for the miniaturization model for the number of devices, generating corresponding miniaturized machine learning models for the number of devices utilizing the selected configuration settings, and deploying the corresponding miniaturized machine learning models to each the number of devices based on the function and the device specifications associated with the number of devices.

The present disclosure relates to machine learning models that can be deployed on edge devices and/or network devices to operate and function at the device. In some embodiments, the machine learning models can allow real time data processing and decision making at the source of the data generation. For example, the machine learning models can be deployed to sensors and device gateways of a monitoring system. In these examples, the machine learning model can be utilized to process data collected by the sensors and provide the processed data to a centralized server or other network device associated with the monitoring system.

In some systems, the machine learning models may be miniaturized to work with the edge devices and/or network devices of a particular monitoring system. As used herein, a miniaturized machine learning model can utilize a smaller number of parameters as compared to a standard large language model and thus, utilize less memory enabling them to be utilized on a device with limited memory and/or low power hardware. For example, the edge devices can have limited hardware resources. In this example, large language models can require relatively high processing, memory, and/or electrical resources to be executed effectively. For this reason, the machine learning model can be miniaturized to be executed on specific hardware resources such that the miniaturized machine learning model can operate effectively utilizing the particular hardware, software, and power constraints of the receiving device.

If the machine learning model exceeds the constraints of the hardware resources of the devices, the devices can crash or become non-functional when the machine learning model is deployed to the device. In some systems, a plurality of edge devices and network devices can operate to perform a particular function, such as monitoring a system of hardware. The plurality of edge devices can each include different hardware, software, and/or power constraints. For this reason, it can be difficult to miniaturize machine learning models for each of the plurality of edge devices that are optimized for the corresponding edge devices.

The present disclosure relates to miniaturization and deployment of machine learning models based on end device capabilities, type of machine learning model, and utilization of the machine learning model when deployed on the device. In these embodiments, the machine learning models can be selected based on input data that is collected (e.g., function of the end device, etc.) by the device receiving the machine learning model. For example, the device can collect temperature data of a part of a system. In this example, the machine learning model can be selected and/or pruned to receive temperature data as an input and generate output data to be utilized by other devices of the system.

In some embodiments, the present disclosure can include selecting configuration settings for the miniaturization model to miniaturize the machine learning model. The configuration settings for the miniaturization model can be based on the device specifications of the receiving device. In this way, the miniaturization model and/or pruning of the machine learning model can be based on the device specifications such as, but not limited to: hardware limitations, software limitations, and/or power limitations of the receiving device. In this way, the present disclosure can customize the miniaturization of the machine learning model such that the miniaturized machine learning model is optimized to operate on the receiving device.

In addition, the specific deployment of miniaturized machine learning models to corresponding devices can ensure that the optimized miniaturized machine learning model is deployed to the correct device. For example, the deployment can ensure that the correct miniaturized machine learning model is deployed (delivered and installed) to the correct device. In these embodiments, the machine learning models can be selected, pruned, and miniaturized to utilize data collected from specific devices as inputs and provide specific outputs to other devices such as a centralized server.

Further, the present disclosure can utilize quality emulation to gather performance specific or qualitative data of the machine learning model running on the corresponding hardware prior to deploying the machine learning model. In this way, the particular miniaturized machine learning model can be tested utilizing the hardware, software, and/or power constraints of the device to receive the particular miniaturized machine learning model prior to deploying the particular miniaturized machine learning model.

In the following detailed description, reference is made to the accompanying drawings that form a part hereof. The drawings show by way of illustration how one or more embodiments of the disclosure may be practiced. These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

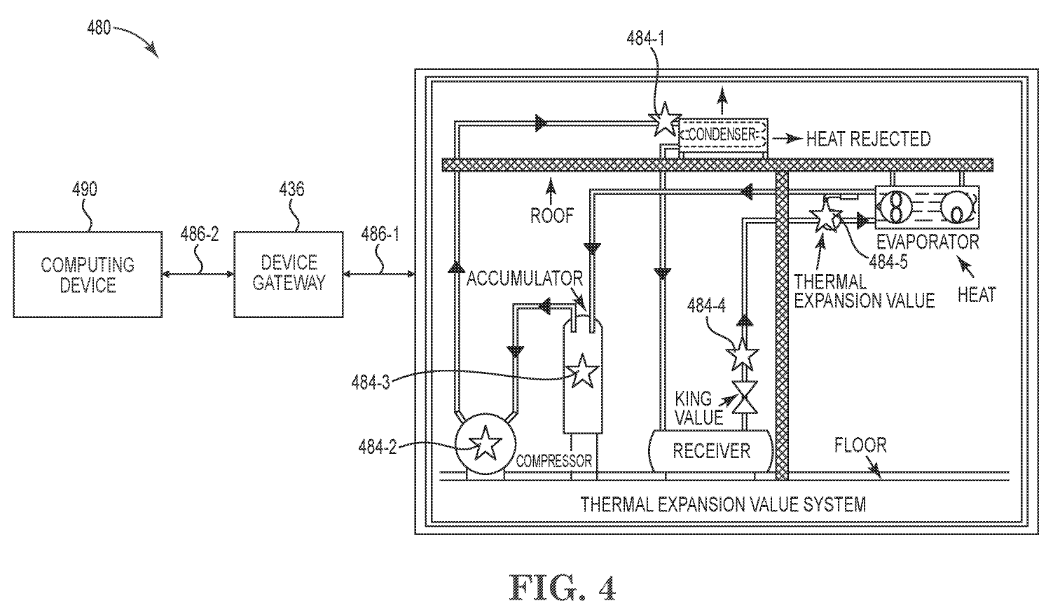

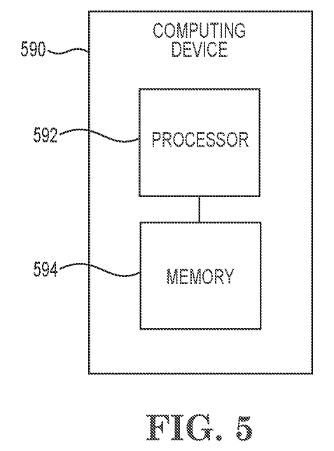

The figures herein follow a numbering convention in which the first digit or digits correspond to the drawing figure number, and the remaining digits identify an element or component in the drawing. Similar elements or components between different figures may be identified by the use of similar digits. For example, 490 may reference element “90” in FIG. 4, and a similar element may be referenced as 590 in FIG. 5.

As used herein, “a”, “an”, or “a number of” something can refer to one or more such things, while “a plurality of” something can refer to more than one such things. For example, “a number of components” can refer to one or more components, while “a plurality of components” can refer to more than one component.

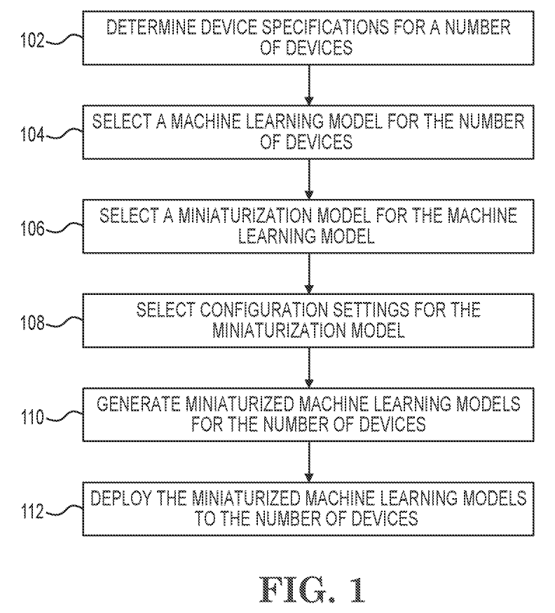

FIG. 1 illustrates an example of a method 100 for automated machine learning model miniaturization and deployment in accordance with one or more embodiments. The method 100 can be performed by, for example, computing device 590, further described in connection with FIG. 5.

In some embodiments, the method 100 can be executed to generate customized miniaturized machine learning models for different devices associated with a system and deploy the customized miniaturized machine learning models to designated devices. In this way, the miniaturized machine learning models can be generated based on the data collected by the different devices, the function of the different devices, the device specifications for executing the miniaturized machine learning model, and/or other factors that can affect how the device utilizes and/or executes the miniaturized machine learning model.

Accordingly, the method 100 can be utilized to select a machine learning model miniaturization and deployment operation for a plurality of miniaturized machine learning models. The method 100 can be executed by a computing device, such as computing device 590 as referenced in FIG. 5 to enable the miniaturized machine learning models to be executed at each of a plurality of edge devices and/or network devices instead of executing the machine learning model at the computing device 590.

At 102, the computing device can determine device specifications for a number of devices. In some embodiments, the number of devices can be devices that are part of a system of devices. For example, the number of devices can be a plurality of devices that are utilized to monitor a mechanical system and/or mechanical device of a mechanical system. In a specific embodiment described further herein, the number of devices can include a plurality of sensors that are located at different areas of a mechanical system (e.g., refrigeration system, computing system, heating ventilation, air conditioning (HVAC) system, and/or other mechanical system that utilizes monitors or sensors to detect a failure or fault of the system, etc.).

In some embodiments, the device specifications can include details of capabilities and/or limitations of the device. For example, the device specifications can include the hardware specifications of the device. The hardware specifications of the device can include, but are not limited to, processing performance, memory resources, storage resources, power delivery limitations, among other hardware specifications that could potentially limit or affect deployment of a machine learning model. In some embodiments, deploying a machine learning model to a device that does not include the hardware specifications to execute the machine learning model can cause the device to crash or become non-functional.

In some embodiments, the device specifications can include software specifications of the device. Software specifications of the device can refer to software, firmware, or other instructions that are stored by the device and/or executed by the processor of the device. In some embodiments, the software specifications can refer to whether or not the device utilizes an operating system or not. In other embodiments, the software specifications can refer to the type and/or version of the operating system when it exists on the device.

In addition, the software specifications can include a version of the BIOS, drivers, or other types of software installed on the device. As described herein, the software specifications can affect if or how a machine learning model performs when executed by the device. For example, particular software may be needed for particular types of machine learning models to function at a particular level of performance. For example, a first device from the number of devices can include an operating system that can execute a particular type of machine learning model while a second device from the number of devices may lack an operating system and may not be able execute the particular type of machine learning model. In some embodiments, deploying a machine learning model to a device that does not include the software specifications to execute the machine learning model can cause the device to crash or become non-functional.

In some embodiments, the computing device can determine hardware specifications (e.g., processor, random access memory (RAM), etc.) and operating system specifications for the number of devices. In some embodiments, the computing device can determine the device specification for a device from the plurality of devices lacks an operating system. In these embodiments, the computing device can alter the configuration settings for the miniaturization model utilized to miniaturize a machine learning model designated for the device in response to the device lacking an operating system. For example, the configuration settings for the miniaturization model to miniaturize the machine learning model can enable the machine learning model to be executed by the device without an operating system. As described herein, a device without an operating system can be damaged or may not be able to execute a miniaturized machine learning model that was generated utilizing configuration settings for a device that includes an operating system.

In some embodiments, the computing device can utilize a first set of configuration settings for devices that are identified as having an operating system and utilize a second set of configuration settings for devices that are identified as lacking an operating system. In other embodiments, the computing device can utilize a first set of configuration settings for devices that include an operating system with a first version that is a greater than a threshold version and a second set of configuration settings for devices that include the operating system with a second version that is less than the threshold version. In this way, the computing device can utilize configuration settings that are going to generate a miniaturized machine learning model that is compatible with the receiving device.

At 104, the computing device can select a machine learning model for the number of devices. In a specific example, the computing device can select machine learning models for each of a plurality of devices based on a function to be performed by the plurality of devices. In some embodiments, the computing device can select the machine learning model for a device based on data that is collected by the device. In some embodiments, the computing device can determine data specifications for data that is collected by the device. For example, the computing device can determine that the device is a sensor that collects temperature data in Celsius at an interval of 30 seconds. In this example, the computing device can select a machine learning model that is able to process temperature data in Celsius at an interval of 30 seconds such that the process data can be provided to a different device and/or provided to the computing device.

As described herein, the device can be utilized to execute the machine learning model instead of having the computing device execute the machine learning model on data received by the device. In the previous example, the machine learning model can be executed by the hardware and/or software of the sensor to generate a particular output that can be utilized by the sensor, the computing device, and/or other devices of the system. This can allow the system to more quickly and accurately generate the output and more quickly respond to the output.

In some embodiments, the computing device can identify a type of device for the plurality of devices. For example, the computing device can identify the type of device is one of a network device, computing device, and/or an edge device. In some embodiments, the computing device can identify the function for the plurality of devices based on the type of device and the device specifications. In some embodiments, the type of device can correspond to a function of the device. For example, the type of device can be a sensor when the function of the device is to sense or collect data. In another example, the type of device can be a network device that can function to provide network communication between devices.

In some embodiments, the type of device can correspond to a calculation performed by the device utilizing input data. For example, the device type can be a sensor when the device monitors data and utilizes the monitored data as an input for a machine learning model. In another example, the device type can be a network device when the device receives data from sensors or other devices connected to the network as input data for a machine learning model. In this way, the device type can be a description of the input data and the calculation to be executed by the device to generate output data.

In some embodiments, the computing device can identify the function for the plurality of devices based on a monitoring system associated with the plurality of devices. In a specific example, the computing device can identify a type of system that utilizes the number of devices. For example, the computing device can identify that the number of devices are utilized to monitor a refrigeration system. In this example, a portion of the number of devices can be sensors that can be utilized to monitor potential leaks of the refrigeration system and a different portion of the number of devices can be utilized to transfer data between the number of devices and a centralized server or cloud resource associated with the refrigeration monitoring system.

In some embodiments, the computing device can utilize the functions of the refrigeration monitoring system to identify the functions of the corresponding number of devices utilized by the refrigeration monitoring system. In this way, the computing device can select machine learning models that are specifically configured to perform a function that can be utilized by the number of devices to perform the corresponding function of the number of devices.

At 106, the computing device can select a miniaturization model for each of the machine learning models. Once the machine learning model is selected for the number of devices, a corresponding miniaturization model is to be selected to miniaturize the machine learning models. As described herein, the machine learning model can be configured (e.g., trained, designed, etc.) to perform a specific task (e.g., specific calculation, specific data conversion, etc.) that can be utilized by the number of devices. In a similar way, the miniaturization model can be configured to miniaturize the machine learning model to a miniaturized model that is capable of being executed by the hardware, software, and/or power constraints of the number of devices.

In previous approaches, it can be difficult to select a compliant miniaturization model and/or compliant configuration setting for the miniaturization model for a particular device with particular hardware, software, and/or power configurations. However, the computing device can be configured to analyze the hardware, software, and/or power configurations for the number of devices and utilize the hardware, software, and/or power configurations to select a particular machine learning model, a particular miniaturization model, and/or configuration settings for the particular miniaturization model according to embodiments of the disclosure.

In a specific example, the computing device can select a miniaturization model for each of the machine learning models based on the function. As described herein, the computing device can select the miniaturization model based on the function of each of the number of devices. In this way, the computing device can select a particular miniaturization model based on the function being performed by a particular device of the number of devices.

In addition, the computing device can utilize the hardware, software, and/or power configurations of each of the number of devices to select the miniaturization model. For example, the miniaturization model can be utilized to lower the computational requirements while retaining the performance of the machine learning model such that the computational requirements of the miniaturized machine learning model are within the hardware, software, and/or power configurations of the number of devices.

In some embodiments, the computing device can select the miniaturization model from a onnx2c model and a model 2 code generator (m2cgen) model. Although a onnx2c model and a m2cgen model are described as potential miniaturization models that can be selected, other existing and future miniaturization models can be utilized in a similar way. As used herein, a onnx2c model can refer to a tool designed to convert machine learning models from the ONNX (Open Neural Network Exchange) format into pure C code. The onnx2c model enables machine learning models to run on platforms where traditional runtime environments or libraries (e.g., TensorFlow, PyTorch, ONNX Runtime) are not available or practical due to resource constraints, such as embedded systems or microcontrollers. By transforming the model into C code, you can directly compile and deploy the model on these types of systems or devices within a system.

As used herein, a m2cgen model refers to a lightweight library that converts trained machine learning models into native code in various programming languages. Unlike traditional inference approaches that rely on specific machine learning (ML) frameworks or libraries at runtime, m2cgen translates the model into standalone source code that can run independently without additional dependencies. Specifically, the m2cgen model can be an open-source Python library that translates ML models into plain, human-readable code in languages such as, but not limited to: Python, C, Java, JavaScript, Go, PHP, Ruby.

As described herein, the particular type of miniaturization model and the configuration settings of the selected type of miniaturization model can be selected based on the hardware, software, and/or power configurations of a device that will be receiving the particular miniaturized machine learning model. In this way, the performance of the miniaturized machine learning model can be maximized within the hardware, software, and/or power restrictions of a device.

At 108, the computing device can select configuration settings for the miniaturization model. In a specific example, the computing device can select configuration settings for the miniaturization model for each of the plurality of devices based on the function and corresponding device specifications for each of the device specifications for the plurality of devices. As described herein, the configuration settings for the miniaturization model can alter the hardware, software, and/or power requirements of the machine learning model. Although specific configuration settings are described herein, additional or fewer configuration settings to alter the requirements or performance of the machine learning model can be utilized.

In some embodiments, the computing device can select the configuration settings by selecting an N-Bit Quantizer, a block size, a symmetric definition, a type, and a version. As used herein, an N-bit quantizer is a technique used in the miniaturization of machine learning models to reduce a size and computational complexity by approximating parameters (e.g., weights, biases) of the machine learning model and activations with lower-precision representations. This is achieved by quantizing the original high-precision values (e.g., 32-bit floating-point numbers) into a smaller number of discrete levels that can be represented using N bits. In a specific example, an N-bit quantizer can map continuous values (e.g., model weights or activations) into a finite set of discrete values that can be represented with 2^{N} levels (e.g., 8-bit quantization provides 256 levels (2⁸)). In these specific examples, the value of N can control a trade-off between precision and efficiency.

As used herein, a block size of the miniaturization model refers to the granularity or unit of processing during compression, optimization, or inference. It plays a critical role in model miniaturization techniques, affecting the efficiency, precision, and computational requirements. For example, a "block" can include a subset of parameters (e.g., weights or activations) or computations in the machine learning model. The block size defines the number of elements or operations grouped together for processing or optimization of the machine learning model. In this example, the block size can determine the number of parameters quantified together.

As used herein, symmetric definition refers to the use of a symmetric quantization or optimization scheme, where the transformations or approximations applied to the machine learning model's parameters, activations, or weights are uniform and centered around a fixed point, typically zero. Symmetry simplifies the representation of the data and improves computational efficiency. In a specific example of symmetric quantization, all values (weights, activations, or other parameters) are quantized relative to a symmetric range around zero and the quantization levels are distributed evenly, with the same step size (delta) for positive and negative values.

At 110, the computing device can generate corresponding miniaturized machine learning models for each of the plurality of devices. In a specific example, the computing device can generate corresponding miniaturized machine learning models for each of the plurality of devices utilizing the selected configuration settings. As described herein, the computing device can generate a particular miniaturized machine learning model for each of a plurality of devices such that each of the miniaturized machine learning models are configured based on the hardware, software, and/or power limitations of the receiving device. In this way, both the machine learning model and the miniaturization model is selected based on the device specifications of the receiving devices.

In some embodiments, the computing device can perform the emulation for a particular miniaturized machine learning model utilizing a device type, a hardware specification, and an operation system specification of a receiving device from the number of devices. In these embodiments, the computing device can perform the emulation for each of the number of devices utilizing corresponding device types, hardware specifications, and operation system specifications for each of the number of devices. In some embodiments, the computing device performs qualitative analysis on the miniaturized machine learning model based on the emulation that utilizes the device specification for a type of device. As used herein, qualitative analysis can refer to a description of qualitative properties (e.g., quality of performance, accuracy of results, stability of system, etc.) of the machine learning model running with particular hardware, software, and/or power specifications. In some examples, the quality of performance is based on an accuracy of the emulated monitoring system utilizing the corresponding miniaturized machine learning models on the number of devices utilizing the hardware specifications.

The qualitative analysis can refer to an analysis of a plurality of qualitative properties or qualitative performance when running the machine learning model with hardware, software, and/or power configurations of a device. For example, the qualitative analysis can utilize qualitative properties such as, but not limited to: a latency of executing the machine learning model, the stability of the device when executing the machine learning model, an accuracy of the machine learning model output, among other properties that can describe a performance of the machine learning model. In this way, the qualitative analysis can provide a value that can correspond to an overall performance of the machine learning model when being executed under particular configurations. In these embodiments, the machine learning model can be further altered when the qualitative analysis is below a threshold value and can be identified as ready to deploy when the qualitative analysis is above the threshold.

At 112, the computing device can deploy the corresponding miniaturized machine learning models to each of the plurality of devices. In a specific example, the computing device can deploy the corresponding miniaturized machine learning models to each of the plurality of devices based on the function and the device specifications associated with the plurality of devices. In some embodiments, the computing device can deploy the miniaturized machine learning model to the number of devices by delivering binaries of the miniaturized machine learning model to the number of devices.

As described further herein, the computing device can deploy a miniaturized machine learning model to a corresponding device of the plurality of devices within a particular system. In some embodiments, the deployment can be part of a system wide update. In this way, a plurality of devices associated with a system can be updated with a corresponding machine learning model.

In some embodiments, the miniaturized machine learning models can be updating or replacing existing machine learning models that are executed by the plurality of devices. For example, the computing device can utilize data to train a machine learning model for a particular device based on the function of the device, miniaturize the machine learning model based on the device configuration, and deploy the miniaturized machine learning model to the device. In this way, the computing device can be responsible for updating or training of the machine learning model to improve the performance of the machine learning model being executed by the receiving devices.

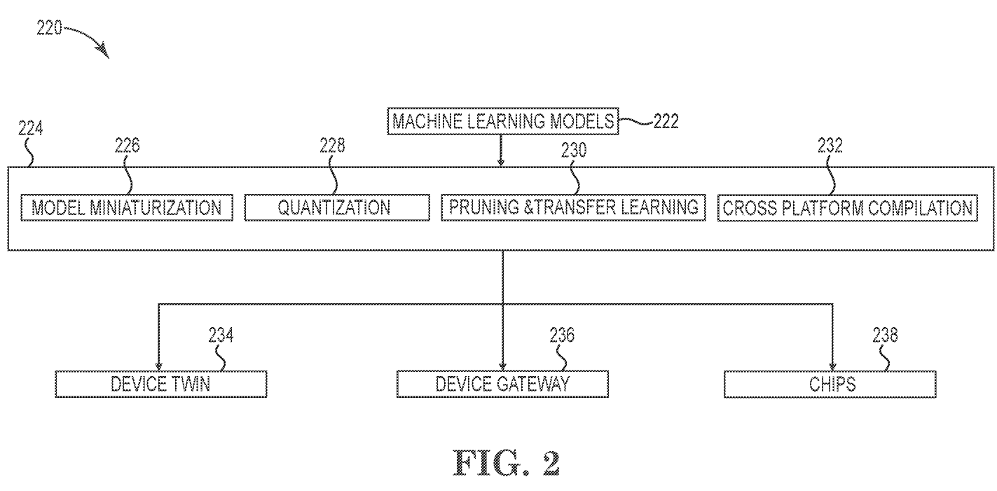

FIG. 2 illustrates an example of a method 220 for automated machine learning model miniaturization and deployment in accordance with one or more embodiments. In some embodiments, the method 220 can be executed by a computing device such as a computing device 590 as referenced in FIG. 5. In some embodiments, the method 220 can be executed by a computing device to generate machine learning models 222 and/or train the machine learning models 222.

As described herein, the machine learning models 222 can be trained to generate particular outputs from inputs collected or monitored by a plurality of devices (e.g., device twin 234, device gateway 236, chips 238, etc.). As used herein, a device twin 234 can refer to a digital representation of a physical device in a monitoring system and/or Internet of Things (IoT) system. It can be a virtual model that stores real-time and historical data, configurations, and states of the physical device, enabling remote monitoring, control, and predictive analytics.

As used herein, a device gateway 236 can refer to a middleware component in an IoT-based monitoring system that acts as an intermediary between edge devices and a computing device (e.g., computing device, server, etc.). The device gateways 236 can control communication by collecting, processing, and forwarding data from multiple devices to a central monitoring system. In some embodiments, the chips 238 can refer to hardware and/or sensors that can be utilized to collect data at a plurality of locations of system being monitored. For example, the chips 238 can include one or more of: a negative temperature coefficient thermistor (NTC Thermistor), a pressure sensor, a humidity sensor, an airflow sensor, and/or vibration sensor. In these embodiments, the chips 238 can monitor a particular type of data and provide the monitored data to a device gateway 236. In some embodiments, a computing device can identify a type of data collected by a particular device of the number of devices and select a corresponding machine learning model to utilize the type of data as an input to generate a particular output.

As described herein, the plurality of devices can each be part of a monitoring system where each of the plurality of devices can receive input data associated with a system or device. For example, the plurality of devices can be part of a monitoring system that monitors a refrigeration system for leaks or other defects in the operation of the refrigeration system. In this example, plurality of devices can include sensors to detect potential leaks, sensors to detect refrigerant flow rate, network devices to collect sensor data, and/or other devices to collect data that can be utilized to identify a leak within the refrigeration system.

In these examples, the plurality of devices can execute a corresponding trained machine learning model 222 such that the collected data can be utilized as an input and an output generated by the machine learning model 222 can be provided to another device or the computing device executing the method 220. In this way, the machine learning models 222 are trained or generated to be optimized for the data collected by the corresponding plurality of devices.

In some examples, the trained machine learning models 222 can be provided to a configuration system 224. In these embodiments, the configuration system 224 can perform a plurality of functions to prepare or configure the machine learning models 222 to be utilized by the plurality of devices. In some embodiments, the configuration system 224 can perform model miniaturization 226, quantization 228, pruning and transfer learning 230, and/or cross platform compilation 232. In this way, the configuration system 224 can be utilized to optimize the machine learning models 222 to be deployed on a specific device of the plurality of devices.

As described herein, the model miniaturization 226 can include a process of reducing the size, complexity, and/or computational demands of a machine learning model 222 while maintaining acceptable levels of performance. In some embodiments, the quantization 228 can include reducing the size and computational requirements of a machine learning model 222 by representing parameters (e.g., weights, activations, computations, etc.) with lower precision data types, such as 8-bit integers (int8) instead of 32-bit floating point (float32).

In some embodiments, the pruning and transfer learning 230 can refer to a method of pruning the machine learning model 222 and transfer learning the machine learning model 222. Pruning the machine learning model 222 can refer to a technique used to remove unnecessary weights, neurons, or layers from a trained machine learning model 222 while preserving its accuracy. In some embodiments, pruning the machine learning model 222 can include weight pruning, neuron/channel pruning, layer pruning, and/or dynamic pruning.

In these embodiments, the transfer learning can refer to a technique that allows a pre-trained machine learning model 222 to be adapted to a new task without training from scratch. Instead of training a model on a large dataset, transfer learning enables leveraging a pre-existing, high-performance model and fine-tuning it for specific needs. As described herein, the plurality of devices can each be a part of the same or similar system. For example, the plurality of devices can be part of a monitoring system where the plurality of devices works together to monitor a performance and/or functionality of the system. In this way, the machine learning model 222 can be trained to monitor the performance and/or functionality of the system and the trained machine learning model 222 can be adapted to function with each of the plurality of devices instead of generating a new or unique machine learning model 222 for each of the plurality of devices.

In some embodiments, the cross-platform compilation 232 can refer to a process of training a machine learning model 222 on one platform (e.g., high-performance GPU servers) and compiling the machine learning model 222 to run on different hardware architectures (e.g., mobile devices, edge devices, embedded systems, or different OS environments). This ensures that the machine learning model 222 can operate on a range of devices without requiring retraining. In some embodiments, the cross-platform compilation 232 can refer to converting the machine learning model 222 from a first format (e.g., Keras, PyTorch, TensorFlow, Open Neural Network Exchange, etc.) to a second format (e.g., intermediate representation, etc.).

The intermediate representation can include, but are not limited to: Open Neural Network Exchange (ONNX), and/or Multi-Level Intermediate Representation (MLIR). In these embodiments, the second format can be hardware-agnostic. As used herein, hardware-agnostic refers to software, algorithms, or machine learning models that are not dependent on a specific hardware platform. This means they can run on different types of processors, architectures, and devices without significant modifications.

In some embodiments, the machine learning model 222 can be configured by the configuration system 224 and deployed to each of the plurality of devices based on the configuration. For example, the configuration system 224 can alter the machine learning models 222 based on the hardware, software, and/or power configurations of the plurality of devices. As described herein, the configured machine learning models 222 can be deployed by deployment modules as an update for a system that includes the plurality of devices.

In some embodiments, a first machine learning model can be configured and deployed to a device twin 234 based on the device specifications. In these embodiments, a second machine learning model can be configured and deployed to a device gateway 236 based on the device specifications. Further, in these embodiments, a third machine learning model can be configured and deployed to chips 238 based on the device specifications. In these embodiments, the configuration system 224 can customize the machine learning models 222 to be deployed on the device specifications of the device twin 234, device gateway 236, and/or chips 238.

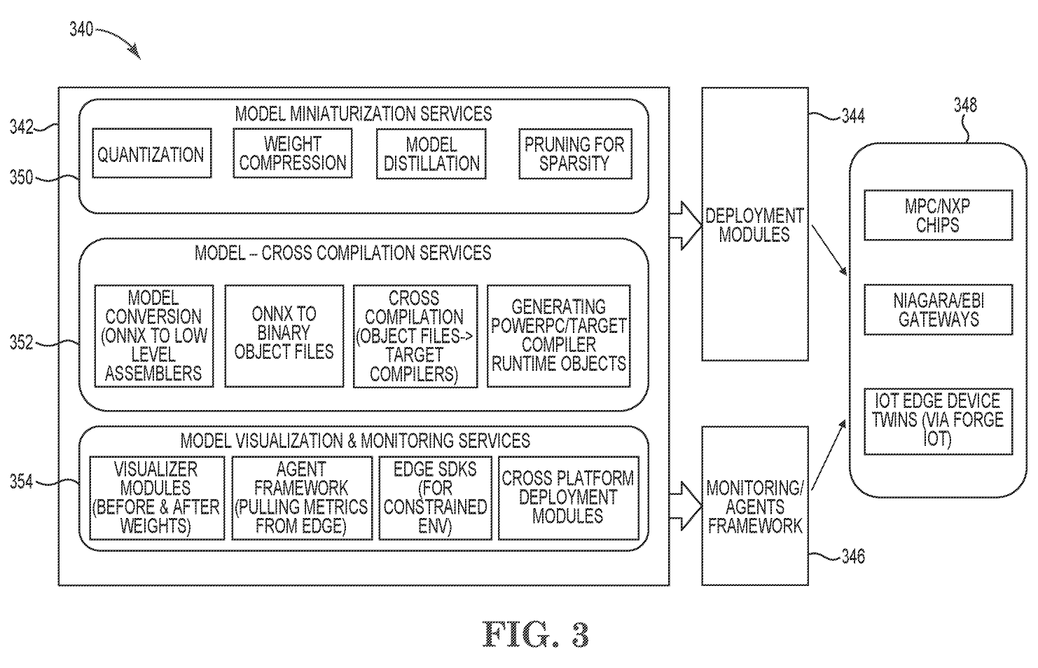

FIG. 3 illustrates an example of a system 340 for automated machine learning model miniaturization and deployment in accordance with one or more embodiments. In some embodiments, the system 340 can illustrate a service system 342 that can perform a plurality of services (e.g., model miniaturization services 350, cross compilation services 352, visualization and monitoring services 354, etc.). For example, the service system 342 can include a plurality of techniques for training and configuring a machine learning model to be deployed to a plurality of devices 348. As described herein, the service system 342 can be executed by one or more computing devices such as computing device 590 as referenced in FIG. 5.

In some embodiments, the service system 342 can perform the same or similar functions as the configuration system 224 as referenced in FIG. 2. For example, the service system 342 can include a model miniaturization service 350 and a cross-compilation services 352 to configure the machine learning models to be deployed to specific devices from the plurality of devices 348. In addition, the service system 342 can include visualization and monitoring services 354.

The model miniaturization services 350 can include quantization, weight compression, model distillation, and/or pruning of a trained machine learning model. As described herein, quantization can refer to a technique used to reduce the memory footprint and computational cost of a machine learning (ML) model by representing weights and activations with lower-precision numerical formats (e.g., int8 instead of float32). In addition, weight compression can refer to a technique used to reduce the memory footprint of a machine learning (ML) model by compressing its weights and parameters. Weight compression can help make models more efficient, faster, and deployable on low-resource devices.

In some embodiments, model distillation or knowledge distillation, can refer to a model compression technique where a smaller, faster model (student model) learns to mimic the behavior of a larger, more complex model (teacher model). The goal is to retain most of the teacher model's accuracy while significantly reducing computational cost and model size. As described herein, pruning for sparsity can refer to a technique used to remove unnecessary weights, neurons, or layers from a trained machine learning model while preserving its accuracy. In some embodiments, pruning the machine learning model can include weight pruning, neuron/channel pruning, layer pruning, and/or dynamic pruning.

In some embodiments, the cross-compilation services 352 can include a model conversion (ONNX to low level assemblers, etc.), a ONNX to binary object files, a cross compilation of object files to target compilers, and/or generating PowerPC/target compiler runtime objects. In some embodiments, model conversion can refer to a process of transforming a trained high-level machine learning model (e.g., TensorFlow, PyTorch) into an optimized low-level representation that can run on specific hardware architectures. Converting ONNX (Open Neural Network Exchange) models into low-level assembly or machine code ensures better performance, efficiency, and compatibility with edge devices, graphic processing units (GPUs), tensor processing units (TPUs), neural processing units (NPUs), and custom hardware.

In some embodiments, performing a conversion of ONNX to binary object files can include converting a ONNX format of the machine learning model to an intermediate representation and compiling the intermediate representation to a binary object file (.o). In some examples, a binary compilation technique such as LLVM, TensorRT, or accelerated linear algebra (XLA) can be utilized to perform the conversion of ONNX to binary object files. As described herein, cross compilation can be performed on the object files to be utilized on target compilers or target devices from the plurality of devices 348. Further the cross-compilation services 352 can generate a target compiler for the runtime objects based on the cross compilation.

In some embodiments, the visualization and monitoring services 354 can utilize visualizer modules to determine performance of a machine learning model before and after weight compression. In addition, the visualization and monitoring services 354 can utilize agent framework by pulling metrics from the plurality of devices 348. For example, the agent framework can be utilized to determine the hardware, software, and/or power specifications for each of the plurality of devices 348. In some embodiments, the visualization and monitoring services 354 can utilize edge software development kits (SDKs). The edge SDKs can include a collection of tools, libraries, APIs, and/or runtime environments designed to help developers build, deploy, and manage the machine learning models and applications on the plurality of devices 348.

In some embodiments, the visualization and monitoring services 354 can include a cross-platform deployment module to package, optimize, and distributing machine learning models so they can run efficiently across different hardware, operating systems, and environments without modification. In some embodiments, the cross-platform deployment modules can utilize the information collected by the visualization and monitoring services 354.

The system 340 can include a deployment module 344 to deploy the configured machine learning models from the service system 342 to the plurality of devices 348. In some embodiments, the system 340 can include a monitoring framework 346 to monitor the deployment and execution of the machine learning models deployed to the plurality of devices 348.

The system 340 can be utilized to configure a trained machine learning model for the plurality of devices 348 based on the device specifications for each of the plurality of devices 348. In this way, the system 340 can ensure that machine learning models that are deployed to the plurality of devices 348 are executable by the plurality of devices 348. In some embodiments, the system 340 can determine an optimized machine learning model for each of the plurality of devices 348 to increase the accuracy of each of the machine learning models and/or an accuracy of the system utilizing the plurality of devices 348.

FIG. 4 illustrates an example of a system 480 for automated machine learning model miniaturization and deployment in accordance with one or more embodiments. The system 480 can illustrate a refrigeration system that can utilize a monitoring system that includes a plurality of devices (e.g., device 484-1, device 484-2, device 484-3, device 484-4, device 484-5, etc.). Although there are five devices illustrated in FIG. 4, additional devices to monitor functions of the refrigeration system can be utilized.

In some embodiments, the system 480 can include a computing device 490. The computing device 490 can be a device similar to computing device 590 as illustrated in FIG. 5. In some examples, the computing device 490 can include instructions that can be executed by a processor to select, minimize, and/or deploy machine learning models to each of the plurality of devices that are specifically configured to be executed by a corresponding device of the plurality of devices.

In some embodiments, the plurality of devices can be communicatively coupled to a device gateway 436 utilizing a first communication pathway 486-1 and the device gateway 436 can be communicatively coupled to the computing device 490 utilizing a second communication pathway 486-2. In some embodiments, the first communication pathway 486-1 and/or the second communication pathway 486-2 can be wired or wireless communication pathways to allow the different devices to send and receive communication.

In some embodiments, each of the plurality of devices can include a chip or sensor to monitor data. For example, the device 484-1 can be a sensor device that is configured to monitor the performance of a condenser. In some embodiments, the device 484-1 can be a hardware device to monitor the performance of the condenser or the device 484-1 can be a twin device that can represent a plurality of sensors associated with the condenser. In these embodiments, the input data collected by the device 484-1 can relate to performance of the condenser or surrounding area of the condenser. In some embodiments, the computing device 490 can identify a type of data collected by the device 484-1 of the plurality of devices and select a corresponding machine learning model to utilize the type of data as an input to generate a particular output. As described further herein, the particular output can be provided to the device gateway 436 as output data.

In this way, the computing device 490 can utilize the device specification of the device 484-1, the type of input data collected related to the performance of the condenser, and/or the type of output data the device 484-1 is providing to the device gateway 436 utilizing the first communication pathway 486-1 to select, miniaturize, and/or deploy a machine learning model to the device 484-1.

In a similar way, the computing device 490 can utilize the device specifications of the device 484-2, input data associated with the performance of the compressor, and output data provided to the device gateway 436 to select, miniaturize, and/or deploy a machine learning model to the device 484-2. In addition, the computing device 490 can utilize the device specifications of the device 484-3, input data associated with the performance of the accumulator, and output data provided to the device gateway 436 to select, miniaturize, and/or deploy a machine learning model to the device 484-3.

In addition, the computing device 490 can utilize the device specifications of the device 484-4, input data associated with the performance of the king valve, and output data provided to the device gateway 436 to select, miniaturize, and/or deploy a machine learning model to the device 484-4. Furthermore, the computing device 490 can utilize the device specifications of the device 484-5, input data associated with the performance of the evaporator, and output data provided to the device gateway 436 to select, miniaturize, and/or deploy a machine learning model to the device 484-5.

In some embodiments, the computing device 490 can utilize the device specifications of the device gateway 436, the input data from the plurality of devices utilizing the first communication pathway 486-1, and/or the output data generated by the device gateway 436 to select, miniaturize, and/or deploy a machine learning model to the device gateway 436. In this way, the computing device 490 can customize a machine learning model for each of a plurality of devices associated with a monitoring system.

As described herein, the computing device 490 can perform an emulation of the customized machine learning model for each of the plurality of devices utilizing the hardware, software, and/or power specifications to ensure the customized machine learning model can be executed by each of the plurality of devices. In addition, as described herein, the computing device 490 can deploy the plurality of customized machine learning models to each of the corresponding devices as a system update such that each of the plurality of devices receive a corresponding machine learning model within the same deployment window (e.g., deployment time period, etc.). This can allow the system to be updated during a single cycle to allow devices within the system 480 to be restarted and/or configured during the down time of the system 480.

FIG. 5 is an example of a computing device 590 for automated machine learning model miniaturization and deployment in accordance with one or more embodiments. As illustrated in FIG. 5, the computing device 590 can include a memory 594 and a processor 592 for configuring machine learning model miniaturization and deployment to a monitoring system, in accordance with the present disclosure.

The memory 594 can be any type of storage medium that can be accessed by the processor 592 to perform various examples of the present disclosure. For example, the memory 594 can be a non-transitory computer-readable medium having computer-readable instructions (e.g., executable instructions/computer program instructions) stored thereon that are executable by the processor 592 for configuring machine learning model miniaturization and deployment to a monitoring system in accordance with the present disclosure.

The memory 594 can be volatile or nonvolatile memory. The memory 594 can also be removable (e.g., portable) memory, or non-removable (e.g., internal) memory. For example, the memory 594 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 594 is illustrated as being located within computing device 590, embodiments of the present disclosure are not so limited. For example, memory 594 can also be located internal to another computing resource (e.g., enabling computer-readable instructions to be downloaded over the Internet or another wired or wireless connection).

The processor 592 may be a central processing unit (CPU), a semiconductor-based microprocessor, and/or other hardware devices suitable for retrieval and execution of machine-readable instructions stored in the memory 594.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
determining, by a computing device, device specifications for a number of devices;
selecting, by the computing device, a machine learning model for the number of devices based on a function to be performed by the number of devices;
selecting, by the computing device, a miniaturization model for the machine learning model based on the function;
selecting, by the computing device, configuration settings for the miniaturization model for the number of devices based on the function and corresponding device specifications for the device specifications for the number of devices;
generating, by the computing device, miniaturized machine learning models for the number of devices utilizing the selected configuration settings; and
deploying, by the computing device, the miniaturized machine learning models to the number of devices based on the function and the device specifications associated with the number of devices.

2. The method of claim 1, wherein the method includes identifying, by the computing device, a type of device for the number of devices, wherein the type is one of a network device, computing device, and an edge device.

3. The method of claim 2, wherein the method includes identifying, by the computing device, the function for the number of devices based on the type of device and the device specifications.

4. The method of claim 3, wherein the method includes identifying, by the computing device, the function for the number of devices based on a monitoring system associated with the number of devices.

5. The method of claim 1, wherein selecting, by the computing device, the configuration settings includes selecting an N-Bit Quantizer, a block size, a symmetric definition, a type, and a version.

6. The method of claim 1, wherein the method includes selecting, by the computing device, the miniaturization model from a onnx2c model and a m2cgen model.

7. The method of claim 1, wherein the method includes determining, by the computing device, the device specification for a device from the number of devices lacks an operating system and in response, altering, by the computing device, the configuration settings for the miniaturization model utilized to miniaturize a machine learning model designated for the device.

8. The method of claim 1, wherein the method includes performing, by the computing device, qualitative analysis on the miniaturized machine learning model based on an emulation that utilizes the device specification for a type of device.

9. A non-transitory computer-readable medium storing instructions executable by a processing resource to cause the processing resource to:
determine hardware specifications and operating system specifications for a number of devices;
select a machine learning model for the number of devices based on a device type defined for the number of devices;
select a miniaturization model for the machine learning model based on the device type of the number of devices;
select configuration settings for the miniaturization model for each of the number of devices based on the device type, hardware specifications, and operation system specifications for the number of devices;
generate a miniaturized machine learning model for the number of devices utilizing the selected configuration settings;
perform an emulation of deploying and executing the miniaturized machine learning model for the number of devices;
determine a quality of performance for the miniaturized machine learning model utilizing the emulation of executing the miniaturized machine learning model; and
deploy the miniaturized machine learning model to the number of devices when the quality of performance is greater than a threshold performance.

10. The non-transitory computer-readable medium of claim 9, comprising instructions to perform the emulation for a particular miniaturized machine learning model utilizing a device type, a hardware specification, and an operation system specification of a receiving device from the number of devices.

11. The non-transitory computer-readable medium of claim 9, comprising instructions to perform the emulation for each of the number of devices utilizing corresponding device types, hardware specifications, and operation system specifications for each of the number of devices.

12. The non-transitory computer-readable medium of claim 11, wherein the instructions to deploy the miniaturized machine learning model to the number of devices include instructions to deliver binaries of the miniaturized machine learning model to the number of devices.

13. The non-transitory computer-readable medium of claim 9, comprising instructions to perform quantization, pruning, and cross platform compilation on the miniaturized machine learning model.

14. The non-transitory computer-readable medium of claim 9, comprising instructions to train the machine learning model for the number of devices based on a function.

15. The non-transitory computer-readable medium of claim 14, including instructions to prune the machine learning model for each of the number of devices based on the function, hardware specifications, and operating system specifications of the corresponding number of devices.

16. The non-transitory computer-readable medium of claim 9, wherein the instructions to deploy the corresponding miniaturized machine learning model includes instructions to remove existing machine learning models and installing the corresponding miniaturized machine learning models.

17. A computing device, comprising:
a processing resource; and
a memory resource storing non-transitory machine-readable instructions to cause the processing resource to:
determine hardware specifications and operating system specifications for a number of devices associated with a monitoring system;
select machine learning models for each of the number of devices based on a device type and function within the monitoring system defined for the number of devices;
select a miniaturization model for each of the machine learning models based on the device type and hardware specifications of each of the number of devices;
select configuration settings for the miniaturization model for each of the number of devices based on the device type, hardware specifications, operation system specifications, and function within the monitoring system for each of the number of devices;
generate corresponding miniaturized machine learning models for each of the number of devices utilizing the selected configuration settings;
perform an emulation of deploying and executing the corresponding miniaturized machine learning models for the number of devices;
determine a quality of performance for the corresponding miniaturized machine learning models utilizing the emulation of executing the corresponding miniaturized machine learning models; and
deploy the corresponding miniaturized machine learning models to each of the number of devices when the quality of performance is greater than a threshold performance.

18. The computing device of claim 17, wherein the quality of performance is based on an accuracy of the emulated monitoring system utilizing the corresponding miniaturized machine learning models on the number of devices utilizing the hardware specifications.

19. The computing device of claim 17, wherein the miniaturized machine learning models are deployed to corresponding devices of the number of devices as an update for the monitoring system.

20. The computing device of claim 17, comprising
instructions to cause the processing resource to identify a type of data collected by a particular device of the number of devices and select a corresponding machine learning model to utilize the type of data as an input to generate a particular output.
